(19) United States
(12) Patent Application Publication
(10) Pub. No.: US 2021/0008939 A1
(43) Pub. Date: Jan. 14, 2021

(54) SUSPENSION FOR A MOTOR VEHICLE

(71) Applicant: AUDI AG, Ingolstadt (DE)

(72) Inventors: Walter SCHMIDT, Rennertshofen (DE); Michael GRADL, Gaimersheim (DE); Thomas KLINGER, Ingolstadt (DE)

(73) Assignee: AUDI AG, Ingolstadt (DE)

(21) Appl. No.: 16/968,682

(22) PCT Filed: Jan. 14, 2019
(86) PCT No.: PCT/EP2019/050813

§ 371 Date: Aug. 10, 2020

(30) Foreign Application Priority Data
Feb. 13, 2018 (DE) 10 2018 202 208.9

(51) Int. Cl. B60G 3/20; B60G 7/00; B62D 5/04; B62D 7/14

(52) U.S. Cl. CPC B60G 3/20; B60G 7/006; B62D 5/0418; B62D 7/146; B60G 2500/40; B60G 2200/44; B60G 2202/42; B60G 2206/11; B60G 2206/121; B60G 2200/144

(57) ABSTRACT

A suspension for a wheel of an axle of a motor vehicle, comprising a wheel support, which is mounted on the vehicle body via a plurality of links and which has a first supporting element and a second supporting element. A vehicle wheel is mounted rotatably on the first supporting element and the first supporting element is rotatable relative to the second supporting element for transmitting a steering torque by a steering actuator arranged on the wheel support. The first supporting element is attached to the vehicle body by an upper wishbone, and the second supporting element is attached to the vehicle body exclusively by a lower wishbone.

The invention relates to a suspension for a wheel of an axle of a motor vehicle according to the preamble of claim 1.

The wheels of a motor vehicle are arranged on the vehicle body in a movable manner via the suspension. The suspension comprises particularly a wheel support to which a vehicle wheel is attached. With a steered axle, the wheel support has, depending on the axle principle, a certain number of links, which connect the wheel support to the vehicle body. At least one lower link, one upper link, and the tie rod are required for wheel control. The tie rod connects the wheel support to a steering gear, usually positioned transversely, which is used to transfer steering torques. However, this type of steered axle requires a lot of installation space.

There are also known designs in which a wheel support is connected to a steering actuator, which can turn the wheel support, in order to implement steering movements directly at the respective vehicle wheel.

For example, DE 102 44 140 A1 discloses an independent link suspension of a vehicle wheel, in which the wheel support is arranged over a pivot bearing. A link is connected to the vehicle body via a suspension strut and supports a steering actuator, which engages the wheel support via a steering arm and can thus rotate it on the link in order to implement steering movements of the vehicle wheel.

DE 10 2010 007 994 A1 discloses a suspension for a vehicle, in which the wheel support has two supporting elements. A first supporting element is arranged on the wheel side, and a vehicle wheel is rotatably mounted thereon. A second supporting element is arranged on the axle side and connected to the vehicle body by means of links. The axle-side and wheel-side supporting elements of the wheel support are coupled together via a universal joint. An actuator is connected between the two supporting elements, upon the actuation of said actuator the wheel-side supporting element can be adjusted as relates to the axle-side supporting element with the aid of drive motors in order to adjust the toe and/or camber angles.

The object upon which the invention is based is to refine a wheel support of a suspension for a wheel of an axle of a motor vehicle according to the type indicated in the preamble of claim 1 such that said wheel support has a simple design and requires minimal installation space.

This object is achieved by the characterizing features of claim 1 in conjunction with its preamble features.

The dependent claims form advantageous refinements of the invention.

In a known way and manner, the suspension of a motor vehicle comprises a wheel support mounted on the vehicle body via several links, said wheel support having a first, wheel-side supporting element, on which a vehicle wheel is rotatably mounted, as well as a second supporting element. The first supporting element can be rotated as relates to the second supporting element by means of a steering actuator arranged on the wheel support.

According to the invention, the first supporting element is connected to the vehicle body by means of an upper wishbone, and the second supporting element is connected to the vehicle body exclusively via a lower wishbone. As a flexible connecting piece between the wheel support and the body, the wishbones enable the freedom of movement of the wheel necessary for steering and absorb the forces acting horizontally. These forces are transferred to the vehicle body via the wishbones. The wishbones thereby contribute to the stable control of the vehicle. As a whole, the design of the suspension according to the invention has an advantageously low number of components and thereby requires little installation space.

According to one embodiment, the first supporting element is connected to the vehicle body by means of an upper wishbone, particularly a link rod. The link rod serves as a flexible connecting piece between the wheel support and the body. It connects the wheel support to the body via a ball joint. In doing so, it enables the freedom of movement of the wheel necessary for steering and absorbs the forces acting horizontally. It thereby contributes to the stable control of the vehicle. Due to its geometry, a link rod takes up limited installation space in an advantageous manner.

In a preferred embodiment, the second supporting element of the wheel support is connected to the vehicle body by means of a lower trapezoidal link. It serves as a flexible connecting piece between the wheel support and the body and is connected to the wheel support via two connection points and connected to the vehicle body via two further connection points. A trapezoidal link has a flat design and is broadly mounted on the vehicle body. In an advantageous manner, it can transfer, due to its wide design, forces acting horizontally and particularly also longitudinal forces to the body upon the acceleration of the motor vehicle. It thereby enables stable control of the vehicle.

Preferably, the first supporting element is mounted in a guide bushing of the second supporting element. The first supporting element can thereby be rotated as relates to the second supporting element in a simple manner and a desired steering angle can be adjusted via the first supporting element of the wheel support.

An alternative embodiment provides that the first supporting element is in the form of a guide bushing, in which the second supporting element is mounted. Thus, the first supporting element can be rotated as relates to the second supporting element, and a desired steering angle can be adjusted via the first supporting element of the wheel support.

Preferably, the second supporting element has a recess for a steering actuator. The steering actuator can be supported, in a manner beneficial to installation space for example, in a cup-shaped recess of the second supporting element. Because of the arrangement of the steering actuator on the second supporting element, it can transfer steering torques directly to the wheel support, and thus to the vehicle wheel. The arrangement of the steering actuator on the second supporting element is especially advantageous, because the steering torques provided by the steering actuator can be supported on the vehicle body via the trapezoidal link.

Preferably, the steering actuator has an electric motor as well as gearing, which may be formed particularly as a planetary gear unit. The electric motor transfers its force to the gearing. Its movements can be transferred directly to the wheel support due to the arrangement of the steering actuator on the wheel support. Thus, the required steering torque can be provided.

Preferably, the first supporting element is actively connected to the steering actuator such that it can cause a rotational movement of the first supporting element. For example, it is conceivable that the first supporting element is mounted in the second supporting element, wherein the first supporting element is designed as a output shaft of the gearing, and the second supporting element is designed as a guide bushing for the output shaft. The transfer of force from the gearing to the output shaft enables a rotation of the first supporting element as relates to the second supporting element. The steering torques provided by the steering actuator can thereby be transferred to the first supporting element, and thus to the vehicle wheel.

It is also conceivable that the second supporting element is designed as an output shaft of the gearing and is mounted in a guide bushing of the first supporting element. A positive-locking connection between the output shaft and the guide bushing ensures that the torque can be reliably transferred from the gearing to the first supporting element. Thus, the first supporting element can be rotated via the steering torques provided by the steering actuator, and a desired steering angle of the vehicle wheel can be adjusted.

In a preferred embodiment, exclusively the steering actuator executes the steering commands For example, a sensor can transmit the steering commands exclusively electrically to the steering actuator via a control unit, with said steering actuator executing the steering command. With this embodiment, there is no mechanical connection between the steering wheel and the steered wheels, as compared to conventional wheel guidance, which requires at least one lower link, one upper link, and a tie rod, wherein the tie rod connects the wheel support to a steering gear, usually positioned transversely, which serves to transfer the steering torques. In an advantageous manner, the suspension according to the invention has a lower number of components and thereby takes up little installation space, which has an advantageous effect on the packaging space.

Preferably, the suspension consists of three assemblies, comprising the upper wishbone, the lower trapezoidal link, as well as the two-part wheel support, which has a first and a second supporting element. Depending on the axle principle, conventional suspensions have up to five links on the wheel support, as well as a transverse steering gear, which is connected to the wheel support by means of a tie rod and is used to steer the axle. The suspension according to the invention has a lower number of components and thereby takes up little installation space, which has an advantageous effect on the packaging space.

Further advantages and application options of the present invention result from the following description in conjunction with the exemplary embodiments shown in the figures.

The following is shown:

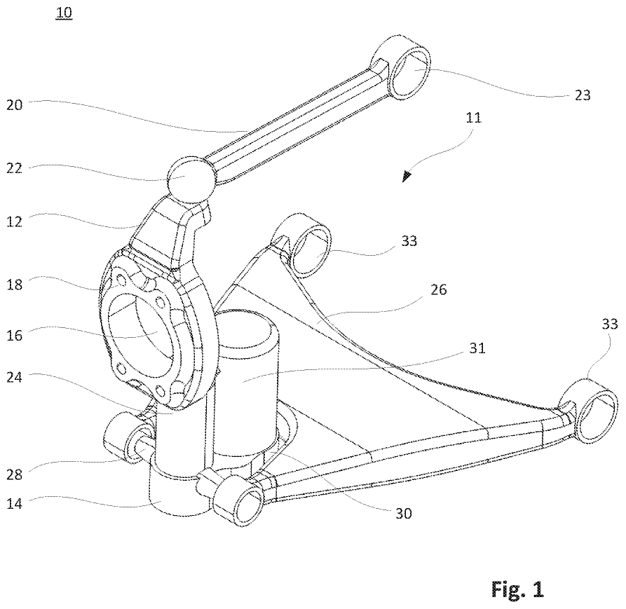

FIG. 1 a lateral top view of the suspension according to the invention;

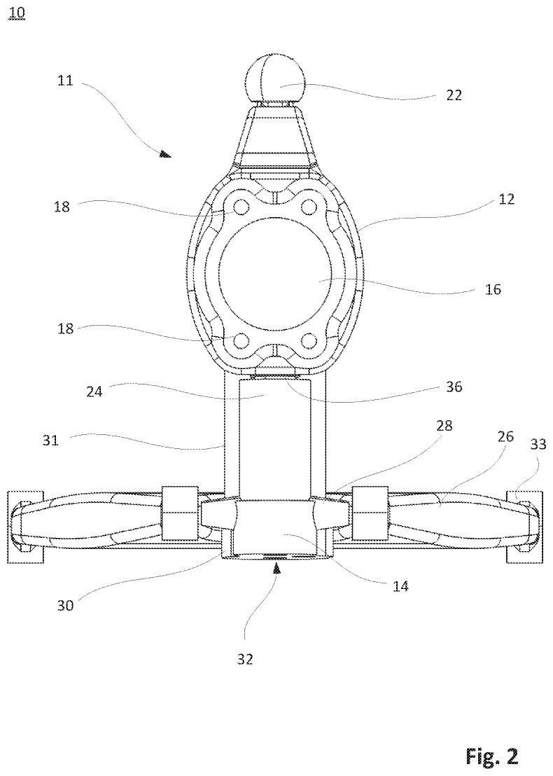

FIG. 2 a front view of the wheel support; and

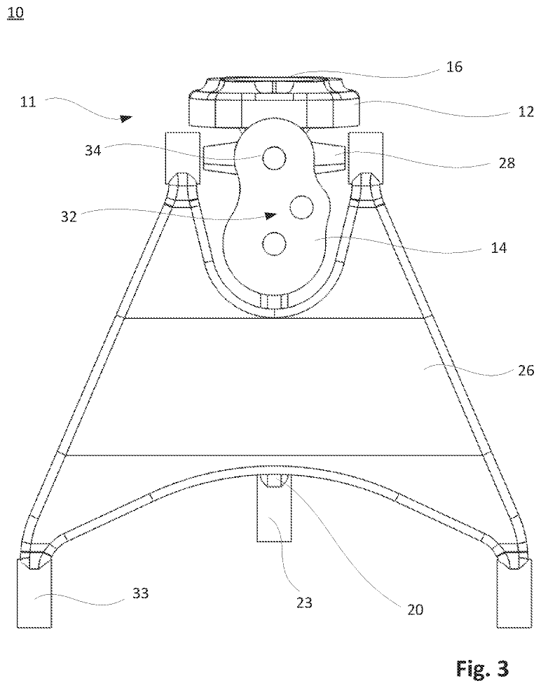

FIG. 3 a view of the wheel support from below.

FIGS. 1 to 3 show, in a schematic representation, a suspension, as a whole characterized by the reference numeral 10, for a wheel of a steered axle of a motor vehicle.

FIG. 1 shows the suspension 10 for a wheel of an axle of a motor vehicle. The suspension 10 comprises a wheel support 11, which is formed in two parts and has a first supporting element 12 as well as a second supporting element 14. A vehicle wheel, which is not shown here, is rotatably mounted on the first, wheel-side supporting element 12. The first supporting element 12 has a wheel bearing 16 as well as connection options 18 for a hub unit.

An upper wishbone 20, which is formed as a link rod in this case, connects the first supporting element 12 to the body of the vehicle. The link rod 20 is connected to the first supporting element 12 by means of a ball joint 22. Thus, the vehicle wheel can move freely up and down and execute steering movements. The vehicle wheel transmits all of the wheel forces occurring to the link rod 20, which is connected to the vehicle body via a bearing 23.

The second supporting element 14 has a cylindrical guide bushing 24, in which a guide column, which is not shown here, of the first supporting element 12 is accommodated. In this manner, the first supporting element 12 is rotatably mounted as relates to the second supporting element 14. Alternatively, it is also conceivable that the first supporting element 12 is formed as a guide bushing 24, which accommodates a guide column assigned to the second supporting element 14, wherein the first supporting element 12 can be rotated as relates to the second supporting element 14.

In this case, the second supporting element 14 has a cup-shaped recess 30 for accommodating a steering actuator 31. The steering actuator 31 is attached directly to the second supporting element 14 of the wheel support 11 in a manner beneficial to the installation space and with a simple design and comprises an electric motor and gearing 32. The electric motor drives the gearing 32 in order to provide the required steering torque. The steering torques provided by the steering actuator 31 are supported on the vehicle body via a trapezoidal link 26.

The trapezoidal link 26 encompasses the cup-shaped recess 30 of the second supporting element 14. The second supporting element 14 is formed with two bearing pins 28, by means of which the trapezoidal link 26 is connected to the second supporting element 14. The trapezoidal link 26 is connected to the body of the vehicle by means of two joints 33. As clearly shown in FIG. 1, the trapezoidal link 26 is a flat wishbone, which is mounted relatively broadly on the vehicle body. Due to its broad design, it can transfer forces acting horizontally as well as longitudinal forces during acceleration of the motor vehicle in order to enable stable control of the vehicle. At the same time, the trapezoidal link 26 supports the steering torques supplied by the steering actuator 31 on the vehicle body.

FIG. 2 shows the two-part wheel support 11 from the front. The embodiment of the suspension 10 according to the invention consists of three assemblies, namely the upper link rod 20, the lower trapezoidal link 26, and the two-part wheel support 11, comprising a first supporting element 12 and a second supporting element 14. Thus, the suspension 10 of the axle according to the invention has a simple design with a low number of components and takes up little installation space in an advantageous manner.

In this case, the guide column 36 of the first supporting element 12 is accommodated in a cylindrical guide bushing 24 of the second supporting element 14. The first supporting element 12 is thereby rotatably mounted in the second supporting element 14. The first supporting element 12 is actively connected to the gearing 32, particularly a planetary gear unit 32, of the steering actuator 31 accommodated in the second supporting element 14. In this manner, the rotation of the first supporting element 12 is enabled by means of the steering actuator 31.

The wheel support 11 of the axle according to the invention is shown from below in FIG. 3. The trapezoidal link 26 encompasses the recess 30, in which the steering actuator 31, comprising an electric motor and gearing 32, is accommodated in a manner beneficial to installation space. In this case, the gearing 32 is designed as a planetary gear unit 32, which enables compact drive technology with high output in an advantageous manner.

The steering actuator 31 converts electrical signals of the steering movement into a mechanical movement of the planetary gear unit 32. The planetary gear unit 32 has a planetary gear 34, which is actively connected to the first supporting element 12 of the wheel support 11. In particular, the transfer of force takes place from the planetary gear unit 32 to the first supporting element 12, and thus to the vehicle wheel, via an output shaft 36 arranged on the planetary gear 34. In this case, the guide column 36 of the first supporting element 12 is designed as an output shaft 36 of the planetary gear unit 32. Thus, with the aid of the steering actuator 31, the first supporting element 12 can be rotated as relates to the second supporting element 14, and a desired steering angle of the vehicle wheel can be adjusted.

1-9. (canceled)

10. A suspension for a wheel of an axle of a motor vehicle, comprising:
a wheel support, which is mounted on the vehicle body via several links, and which has a first supporting element and a second supporting element, wherein a vehicle wheel is mounted rotatably on the first supporting element, wherein the first supporting element is rotatable relative to the second supporting element for transmitting a steering torque by means of a steering actuator arranged on the wheel support,
wherein the first supporting element is attached to the vehicle body by an upper wishbone, and the second supporting element is attached to the vehicle body exclusively by means of a lower wishbone.

11. The suspension according to claim 10, wherein the upper wishbone is a link rod.

12. The suspension according to claim 10, wherein the lower wishbone is a trapezoidal link.

13. The suspension according to claim 10, wherein the first supporting element is mounted in a guide bushing of the second supporting element.

14. The suspension according to claim 10, wherein, the second supporting element is mounted in a guide bushing of the first supporting element.

15. The suspension according to claim 10, wherein the second supporting element has a recess for the steering actuator.

16. The suspension according to claim 15, wherein the steering actuator has an electric motor as well as gearing.

17. The suspension according to claim 10, wherein the first supporting element is actively connected to the steering actuator.

18. The suspension according to claim 10, wherein the suspension comprises three assemblies, comprising the two-part wheel support, the upper wishbone, as well as the lower wishbone.

19. The suspension according to claim 11, wherein the lower wishbone is a trapezoidal link.

20. The suspension according to claim 11, wherein the first supporting element is mounted in a guide bushing of the second supporting element.

21. The suspension according to claim 12, wherein the first supporting element is mounted in a guide bushing of the second supporting element.

22. The suspension according to claim 11, wherein the second supporting element has a recess for the steering actuator.

23. The suspension according to claim 12, wherein the second supporting element has a recess for the steering actuator.

24. The suspension according to claim 13, wherein the second supporting element has a recess for the steering actuator.

25. The suspension according to claim 14, wherein the second supporting element has a recess for the steering actuator.

26. The suspension according to claim 11, wherein the first supporting element is actively connected to the steering actuator.

27. The suspension according to claim 12, wherein the first supporting element is actively connected to the steering actuator.

28. The suspension according to claim 13, wherein the first supporting element is actively connected to the steering actuator.

29. The suspension according to claim 14, wherein the first supporting element is actively connected to the steering actuator.
